(19) United States
(12) Patent Application Publication
(10) Pub. No.: US 2010/0212331 A1
(43) Pub. Date: Aug. 26, 2010

(54) CRYOPRESERVATION METHOD AND DEVICE

(75) Inventors: John K. Critser, Columbia, MO (US); Xu Han, Columbia, MO (US); Hongbin Ma, Columbia, MO (US)

Correspondence Address: POLSINELLI SHUGHART PC, 700 W. 47TH STREET, SUITE 1000, KANSAS CITY, MO, 64112-1802, US

(73) Assignee: The Curators of the University of Missouri, Columbia, MO (US)

(21) Appl. No.: 12/374,622

(22) PCT Filed: Jul. 21, 2007
(86) PCT No.: PCT/US07/74055

§ 371 Date: Mar. 26, 2010

Related U.S. Application Data
(60) Provisional application No. 60/832,431, filed on Jul. 21, 2006.

(51) Int. Cl. A01N 1/00

(52) U.S. Cl. 62/51.1

(57) ABSTRACT

A device and method suitable for the cryopreservation of all types of biological cells is described. In this method, an ultra-fast cooling/warming device system is used to achieve vitrification of individual cells or cell suspensions without cryoprotectant agents (CPA) or with a low concentration of CPAs (<1M), to attenuate the formation of intracellular ice crystal formation during cooling, and to minimize devitrification during subsequent warming. The device system applies oscillating heat pipe (OHP) and nanofluid techniques, and is built through microfabrication. Several devices may be networked to increase the total volume of cell samples that the cryopreservation system can process simultaneously.

### RELATED APPLICATION

This patent application claims priority from U.S. provisional patent application Ser. No. 60/832,431, filed Jul. 21, 2006, which is incorporated herein by reference in its entirety.

### FIELD

This application relates to a method for the fast cryopreservation of a variety of biological cell samples, whereby any of a variety of cells are cooled with little or no cryoprotectant agent and at a rate sufficient to prevent ice crystal formation. More particularly, the present invention relates to a novel device used in the cryopreservation of cell samples, whereby the device facilitates spreading a suspension of cells into a thin layer to maximize the contact area of the cell sample with the cooling surface, whereby the cell samples are cooled at a rate of at least 10⁶-10⁷ K/min.

### BACKGROUND

Cell cryopreservation, the process of exposing cells to extremely low temperatures (−80° C. to −196° C.), makes possible the long-term storage of living cells; however, a major drawback of cryopreservation is that many cryopreservation procedures can cause significant cell damage. The viability of a cell that is revived after undergoing such procedures depends on whether the damage can be prevented or minimized. When cells are cooled to the low storage temperature involved in cryopreservation, one major concern is the formation of intracellular ice.

Intracellular ice formation (IIF) is generally believed to be fatal to a cell due to the mechanical damage to the cellular ultrastructure either by the direct action or by the associated volumetric expansion of ice crystal formation. One technique to minimize the risk of IIF is the incorporation of cryoprotectant agents (CPAs) into the cryopreservation process. Permeating CPAs, possessing both the property of lowering the freezing point and the ability to pass through cell membranes, are widely used to reduce the chance of IIF during cryopreservation. The use, however, of permeating CPAs also has potentially toxic effects on cells at high CPA concentrations and may cause osmotic damage during the addition and removal of the agents. To avoid the detrimental effects that commonly occur during cryopreservation, two general approaches are commonly used in cryopreservation: 1) equilibrium (slow freezing) procedures or 2) non-equilibrium (vitrification) cooling procedures.

In equilibrium cooling approaches, cells are initially exposed to a relatively low CPA concentration (1-2M) and then cooled slowly at a rate of about 1 K/min, resulting in gradual ice formation in the extracellular solution. There are two major disadvantages to the equilibrium cooling approach: 1) ice crystals formed in the extracellular solution may cause direct mechanical damage to the cell membrane or other fine structures (such as sperm tails) and can be lethal in terms of the loss of cell biophysical function, and 2) a tightly controlled optimal cooling rate is required to obtain the highest survival rate of the preserved cells. The procedures to determine the optimal cooling rate are complex because they are dependant on individual cell characteristics. Because the cooling requirements for cryopreservation are different from one cell type to another, different cell types require different cooling devices. These disadvantages limit the application of the equilibrium cooling approach as a reliable or efficient method for preserving biological cells.

The vitrification approach to cryopreservation maintains the whole cell suspension in a vitreous state and prevents both intracellular and extracellular ice formation. It is traditionally achieved by the combined use of a relatively high concentration of CPAs (usually 4 to 7 M) and a relatively fast cooling rate in excess of the critical cooling rates (the minimum cooling rate to vitrify a solution). Currently available cooling methods, such as the open pulled straw (OPS) method, the cryo-loop method, the micro-droplet method, and the solid-surface method, in combination with high concentrations of CPAs, can achieve the vitrification of biological samples. The vitrification approach utilizes high CPA concentrations to avoid IIF, which may have damaging effects on cells as discussed above.

Because of the limitations of existing cryopreservation techniques, and the absence of a single methodology that would result in the successful cryopreservation of a wide variety of cell types, there is no consensus as to which technique of cryopreservation is most suitable, and the lack of standardization in cryopreservation procedures has led to a chaotic collection of procedures and devices that are individualized to each cell type. In addition, many cell types that are important to the medical research community such as mouse sperm, porcine embryos, and granular white blood cells are not as likely to be properly preserved due to a lack of a proven cryopreservation methodology that is appropriate for many different cell types. Therefore, developing a universal, efficient cell cryopreservation approach and corresponding devices is of critical importance.

Vitrification of cell suspensions with no or a low concentration of CPAs would be suitable for almost all cell types, and is a potentially universal approach for cell cryopreservation. However, vitrification can occur in a biological sample only if the sample is cooled at an ultra-fast cooling rate on the order of 10⁶-10⁷ K/min (rate of temperature drop in Kelvins per minute) or higher. Current cooling technologies such as dropping a small volume of cell suspension (around 1 μl) directly into liquid nitrogen only produces a cooling rate of approximately 10⁴ K/min, due to a vapor coat that forms around the surface of the sample and insulates the sample against a more rapid temperature loss. Thus, it is desired to cool the cell samples at a rate of at least 10⁶-10⁷ K/min.

For convective heat transfer processes such as those named above, the cooling rate of the sample by a specific coolant is limited by: 1) the value of the heat transfer coefficient between the sample surface and the coolant; and 2) the ratio of contact surface area (between the coolant and the sample) to the volume of the sample (S/V ratio). To achieve vitrification of cell suspensions with less than 1M CPA or even without CPA, an ultra-high heat transfer coefficient (10⁶W/m²K) is required for a sample of 10-100 μm diameter. Current methods of cryopreservation fall well short of generating cooling rates that are sufficiently high to induce vitrifaction. A novel technology capable of generating much higher cooling rates than can be achieved with current technology would make possible the vitrification of cell samples with little or no CPAs added.

### SUMMARY

In an embodiment, a cryopreservation system comprised of a cryopreservation device with an associated oscillating heat pipe (OHP), condenser, and evaporator, is provided, along with methods of cooling and warming cell samples. The novel design of the cryopreservation device achieves unprecedented high rates of cell sample heating and cooling, making possible the vitrification of cell samples with little or no cryopreservative required in the cooling or warming process. The novel design of the cell sample container forms the cell sample into a thin layer block, with a depth of 50-200 μm, which maximizes the surface area of the cell sample in contact with the cooling surface of the container. Further, through microfabrication technology, the thickness of the cooling surface of the cryopreservation device is between 50 μm and 200 μm. In another embodiment the device is approximately 100 μm, minimizing the amount of material through which the coolant must transfer heat from the cryopreservation device. In one embodiment, silicon, a material with ultra-high heat conduction properties at cryogenic temperatures is used to construct those parts of the cell sample container in contact with the cell sample and the coolant. Microscopic channels (50-200 μm diameter) in the cell sample container, also fabricated using microfabrication techniques, carry coolant at high speeds past the cell sample, thereby enhancing the heat transfer process by means of conduction. Lastly, an OHP connected to the cryopreservation device induces a rapid flow of coolant through channels and continuously replenishing the coolant in the cryopreservation device. All of these novel design features, in combination, make possible cooling and heating rates in excess of 10⁶ K/min.

Additional objectives, advantages and novel features will be set forth in the description which follows or will become apparent to those skilled in the art upon examination of the drawings and detailed description which follows.

The present invention limits the exposure of cells to potentially toxic CPA levels and is a virtually universal method of cryopreservation. It is suitable for nearly any cell type, and increases the likelihood of preserving cell types that are of great importance to the medical community.

### BRIEF DESCRIPTION OF THE DRAWINGS

FIG. 1 is a graph showing the results of a numerical simulation to assess the effect of container thickness on average cooling rates at different locations inside a thin layer cell sample of 100 μm in thickness.

FIG. 2 is a graph showing the results of a numerical simulation to assess the effect of cell sample thickness on average cooling rates at different locations inside a cell sample container with a thickness of 50 μm.

FIG. 3 is a graph showing the results of a numerical simulation to assess the effect of container thickness on average warming rates at different locations inside a thin layer cell sample of 100 μm in thickness.

FIG. 4 is a graph showing the results of a numerical simulation to assess the effect of cell sample thickness on average warming rates at different locations inside a cell sample container with a thickness of 50 μm.

FIG. 5 is a perspective view of the cryopreservation device connected to an oscillating heat pipe (OHP).

FIG. 6 is a top view of the OHP of the present device.

FIG. 7 is an exploded view of the cryopreservation device showing the connection adapter and the sample container.

FIG. 7 is a perspective view of the connection adapter.

FIG. 8A is a cross-sectional view of the connection adapter, showing the interior coolant passages and valves in one embodiment.

FIG. 8B is a cross-sectional view of the sample container mounted in the connection adapter, showing the path of coolant flow through the connection adapter and sample container when the valves are set to the operating position.

FIG. 8C is a cross-sectional view of the sample container mounted in the connection adapter, showing the path of coolant flow through the connection adapter when the valves are set to the non-operating position.

FIG. 9 is an exploded view of the sample container.

FIG. 10 is a cross-sectional view of the sample container.

FIG. 11 is a perspective view of a network of cryopreservation devices.

Corresponding reference characters indicate corresponding elements among the views of the drawings. The headings used in the figures should not be interpreted to limit the scope of the claims.

### DETAILED DESCRIPTION

The present invention is directed to a cryopreservation device and method for vitrification of a cell sample and for subsequently removing the cell sample from vitrification using a novel ultra-fast cooling/warming device. The device features a novel cell sample container that spreads the cell sample into a single-cell layer, thus maximizing the surface area of the cell sample in direct contact with bottom of the cell sample container. Microscopic channels constructed using microfabrication techniques conduct the flow of coolant beneath the flat block cell sample with only 50-200 μm of container material separating the coolant flow from the cell sample. The cell sample container may be constructed out of silicon, a material that has ultra-high thermal conductivity at cryogenic temperatures, to further facilitate rate of cooling of the cell sample. When mounted in a novel connection adaptor, the device is connected to an oscillating heat tube, which continuously circulates fresh coolant through the sample container. To further enhance the rate of heat transfer between the sample and the coolant, nanoparticles with high thermal conductivity may be mixed with the coolant. The cryopreservation system, comprised of the cryopreservation device and the associated oscillating heat tube, is capable of achieving cooling rates of 10⁶-10⁷ K/min (rate of change of the temperature of the cell sample in Kelvins per minute). At these extremely high rates of cooling, the cell samples are cooled to cryogenic temperatures with a minimum of ice crystal formation, using little or no cryoprotective agents in the cell sample. Because of valves that are incorporated into the novel design of the connector adapter, a network of two or more cryopreservation devices may be connected to one oscillating heat pipe, and the cell sample containers may be attached and detached from the cryopreservation system independently of each other. This design of the system increases the overall capacity of the system to cool cell samples and allows for flexibility in the timing and sequence of cryopreserving cell samples.

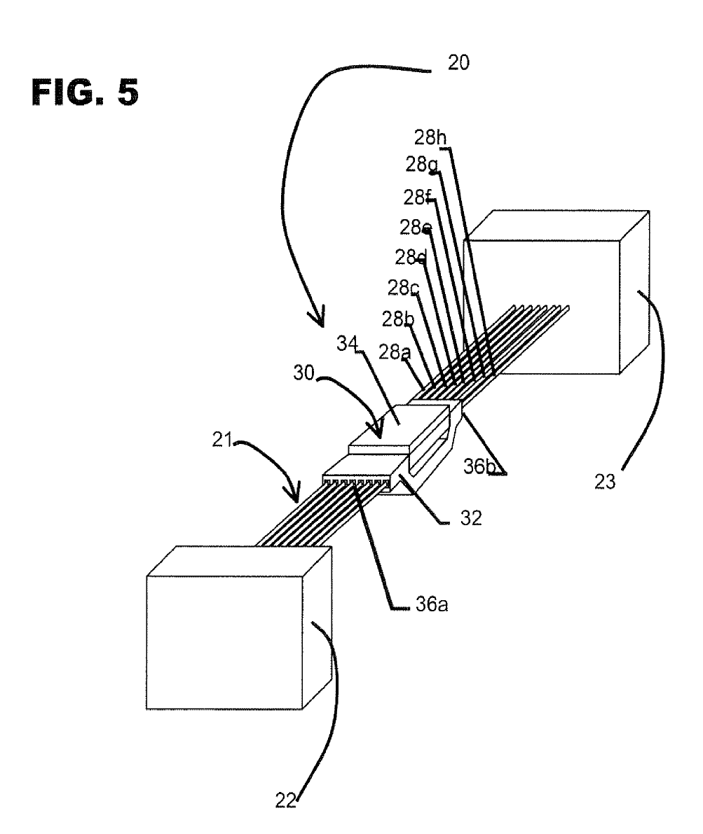

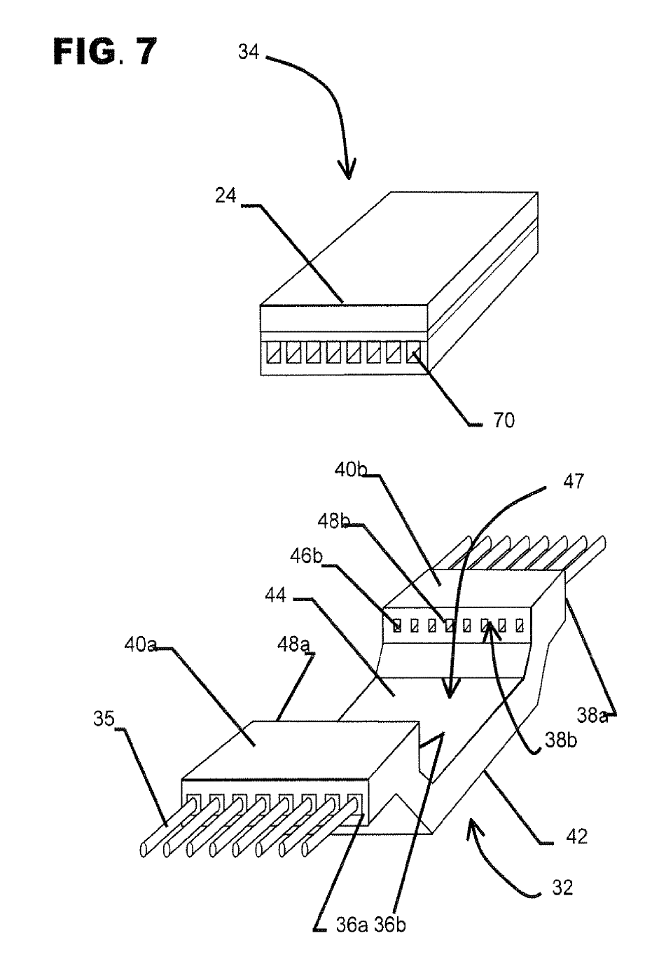

Referring to the drawings, the cryopreservation system 20 is illustrated and generally indicated in FIG. 5. The system 20 includes a cryopreservation device 30, and an oscillating heat pipe (OHP) 21 with its associated condenser 22 and evaporator 23. The device 30 is connected to the OHP to allow the passage of coolant through the device. The planar top of the device 30 is the cell sample container 34, constructed of silicon, in which the cell sample is held in a flat single-cell layer in close proximity to the flow of coolant from the OHP 21. Opposite the cell sample container 34 of the device 30 is a connector adapter 32 in which the cell sample container 34 is removably mounted. The opposable sides 36a and 36b of the device 30, contain fittings 35 (see FIG. 7) that connect the OHP 21 to internal channels 46a and 46b that conduct coolant to the coolant channels 70 of the cell sample container 34. The base 42 of the connector adapter 32 that contains internal coolant channels 50 that divert coolant from the OHP 21 away from the cell sample container 34 to allow the cell sample container 34 to be removed from the connector adapter 32 independently of other devices 30 that may be connected to the same OHP 21.

The OHP 21 passes into an evaporator 23, of standard design in the industry, which adds heat (and therefore pressure) to the coolant, inducing the flow of coolant through the heat pipe. In addition, the OHP 21 passes into a condenser 22 located opposite of the evaporator 23, of standard design in the industry, which absorbs heat (and reduces pressure) from the coolant, further inducing the flow of coolant through the heat pipe. OHP 21 includes at least one pipe member, for example 23a, b, c, d, e, f, g, and h, and preferably includes multiple members so as to facilitate a rate of cooling sufficient to induce vitrification in the cell sample when cooling. As such, a variety of arrangements and structures may be used so long as the cell samples are adequately cooled at a rate of at least 10⁶ K/min.

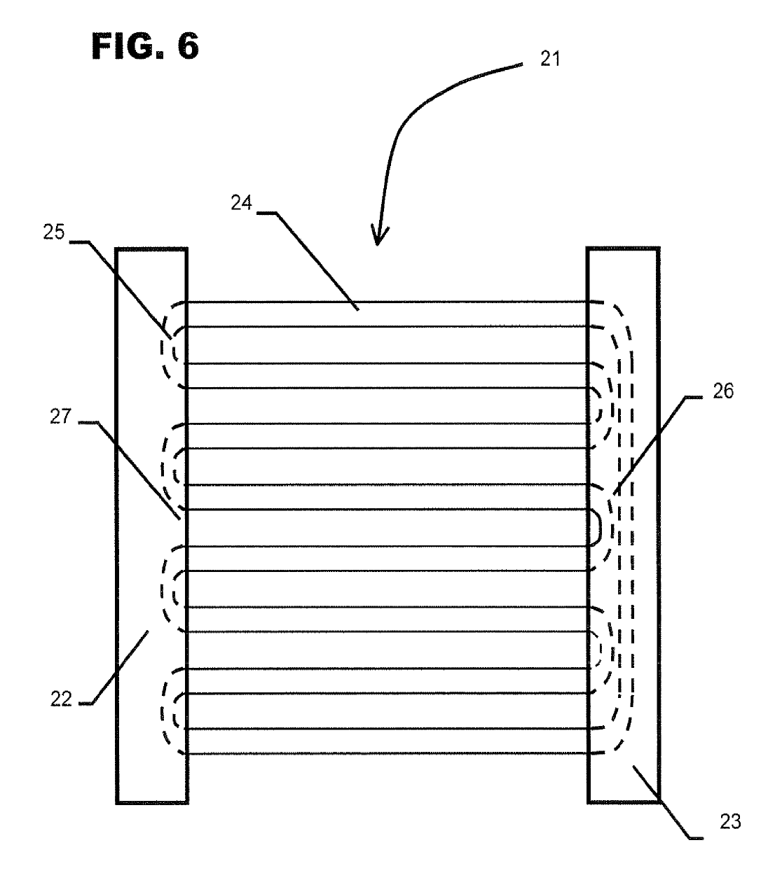

FIG. 6 shows the oscillating heat pipe (OHP) 21, a small diameter flexible metal pipe forming a continuous loop, that is folded into a succession of parallel straight sections 24, connected by 180 degree bends 25 on either end in a zig-zag pattern. The numerous bends 25 in the vicinity of the evaporator 23 form a heat receiving region 26, and the numerous bends 25 in the vicinity of the condenser 22 form the heat radiating region 27 of the heat pipe. The heat receiving region 26 of the heat pipe passes through an evaporator 23, which adds heat to the coolant via conduction through the metal wall of the heat pipe. The heat radiating region 27 of the pipe passes through the condenser 22, which removes heat from the coolant via conduction through the metal wall of the heat pipe. The coolant is induced to move through the heat pipe at high velocity by the pressure difference between the coolant in the heat receiving region 26 (higher pressure) and the coolant in the heat radiating region 27 of the heat pipe (lower pressure). Pressure-sensitive valves (not shown) located along the heat pipe ensure that the coolant flow is unidirectional as the coolant oscillates between the heat radiating region in the condenser and the heat receiving region in the evaporator.

The cryopreservation device 30 includes at least two primary parts, shown in FIG. 7: a connection adapter 32, into which fits a sample container 34. A cell sample to be cryopreserved (not shown) is placed into the sample container 34. The cover 62 is then actuated to cause the cell sample to spread into a thin layer block, which has a high ratio of surface area to volume ratio. The sample container 34 is placed into the connection adapter 32 and low-temperature coolant flowing from the OHP 21 through the sample container 34 will result in the removal of heat from the cell sample, causing the cell sample to undergo vitrification. The sample container 34 can then be removed from the connection adapter 32, and stored at cryogenic temperatures for extended periods. To reheat the cell sample, the sample container 34 is removed from cold storage and placed into the connection adapter 32. Coolant, for example water, flowing from the OHP 21 rapidly reheats the cell sample, bringing the cell sample back up to biological temperatures while avoiding devitrification of the cell sample.

The comparatively fast rates of cooling and heating of at least 10⁶ K/min are sufficient to induce the vitrification of cell samples during cooling as well as avoid the devitrification of cell samples during warming without need for the high concentrations of CPAs used in other cryopreservation methods. The comparatively rapid rates of cooling and heating result from several novel design features of the cryopreservation device 30. The device 30 utilizes thin film evaporation techniques, in which the coolant flowing in small diameter tubes past the cell sample evaporates against the walls of the tubes, efficiently transferring the heat from the sample to the coolant. The continuous rapid flow of coolant past the cell sample induced by the OHP 21 convects heat away from the cell sample, further increasing the efficacy of the heat transfer process. The design of the cell sample container 34 also minimizes the thickness of container material separating the coolant and the cell sample to 50-200 μm, minimizing heat losses to the material of the sample tray 60 during the heating or cooling process.

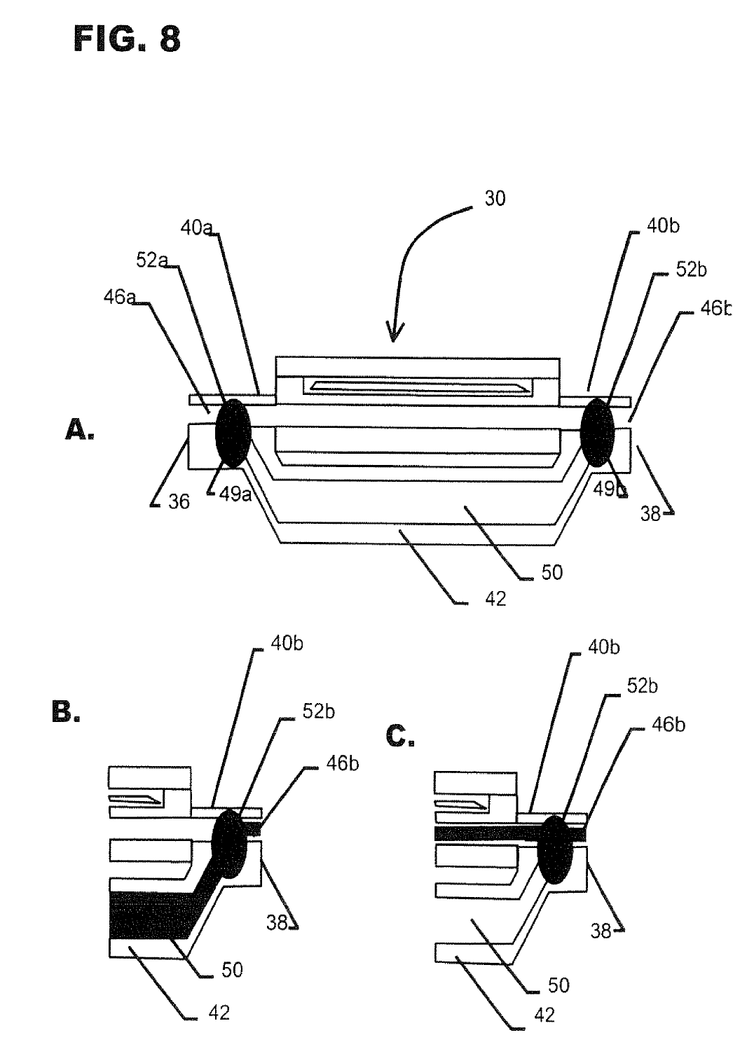

Referring now to FIG. 7 and FIG. 8, the connection adapter will be discussed in greater detail. Two wings 40a and 40b, integrally attached to either side of a planar member 42, form a U-shaped design 44 (on the upper surface of the connection adapter 32), in which the sample container 34 operatively engages and removably connects. The material of the two wings 40a and 40b define the internal walls of one or more hollow internal upper coolant channels 46a and 46b. The upper coolant channels 46a and 46b run through the interior of each wing 40a and 40b and communicate between the opposed sides 36 and 38, to the walls 48a and 48b, respectively, of the U-shaped design 44. The material of the planar member 42 defines the internal walls of one or more hollow internal lower coolant channels 50 (see FIG. 8). The lower coolant channel 50 communicates between the upper coolant channels 46a and 46b via a Y-intersection 49a and 49b, shown in FIG. 8, with the upper coolant channels 46a and 46b. Two or more valves 52a and 52b, operatively connected to the upper and lower coolant channels 46a, 46b, and 50, control the flow of coolant by diverting coolant flow through the upper coolant channels 46a and 46b during operation of the cryopreservation system 20 when the sample container 34 is connected to the connection adapter 32, as shown in FIG. 8B. Conversely, the coolant can be diverted to the lower coolant channel 50 when the sample container 34 is not mounted on the connection adapter 32, as shown in FIG. 8C. In another embodiment, two valves (not shown) on each end of the connection adapter (one in each of the upper coolant channels 46a and 46b, and one the lower coolant channel 50) are used to control coolant flow through the connection adapter 32.

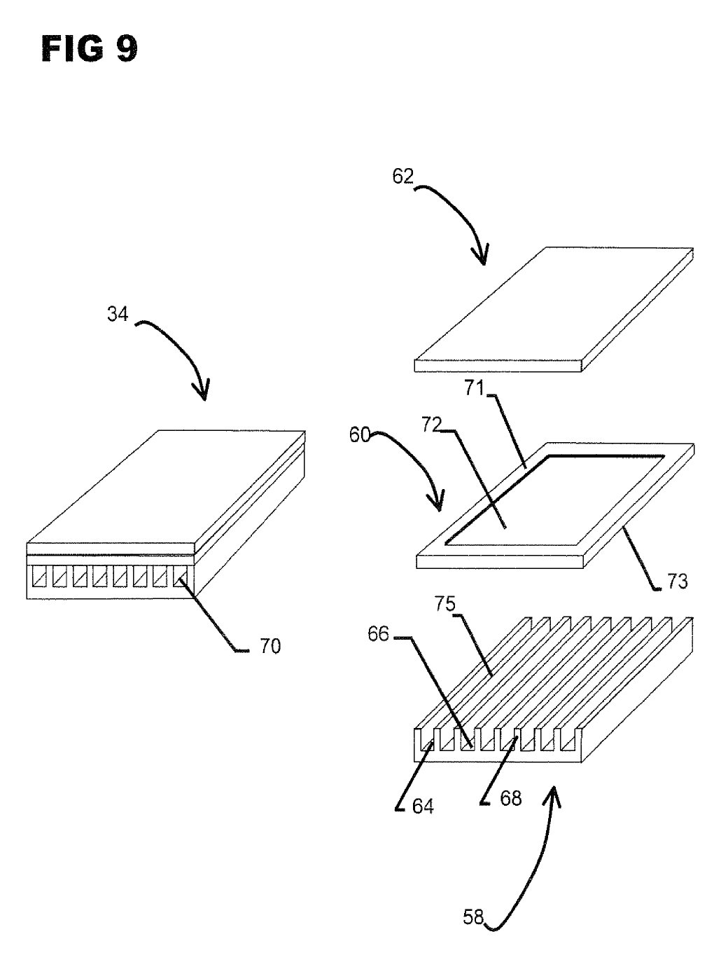

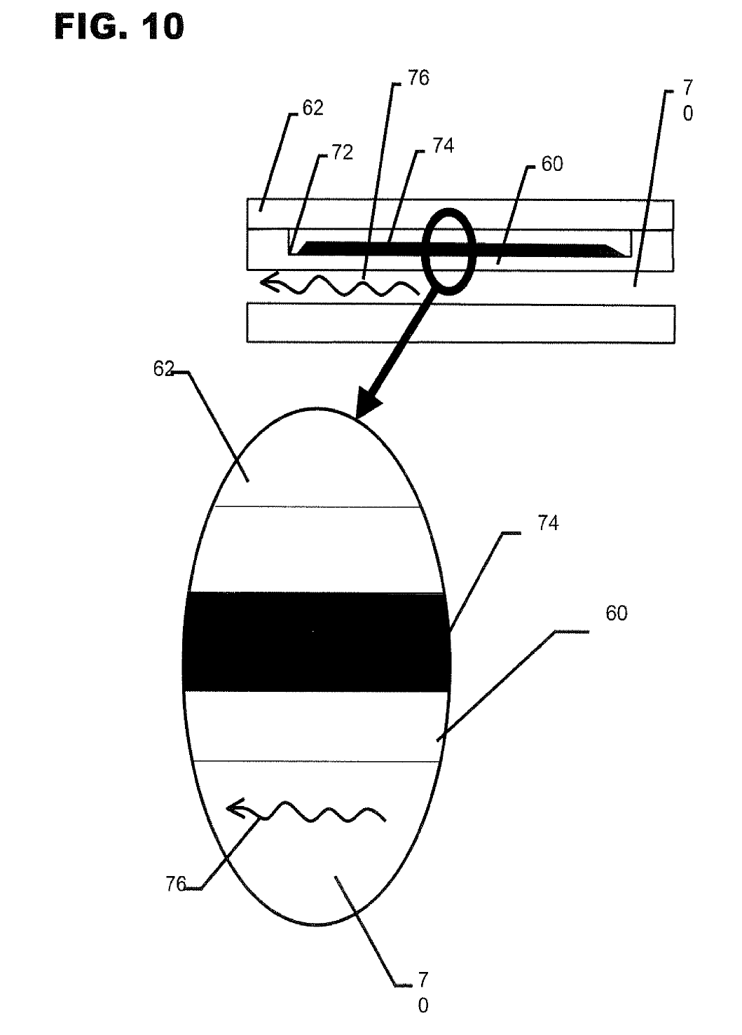

Referring now to FIG. 7 and FIG. 9, the sample container 34 will now be discussed in detail. The sample container 34 is comprised of at least three parts: a base 58, a sample tray 60, and a cover 62. The flat base 58 is engraved or embossed with at least one straight channel 64 with a U-shaped cross-section, that defines the bottom wall 66 and side wall 68 of one or more coolant passage channels 70. The flat sample tray 60 has a slight recess 72 in which the cell sample (not shown) is placed. The lower surface 73 of the sample tray is flat, and is adhered to the upper surface 75 of the base 58 to form the upper surface of the coolant passage channels 70. The coolant passage channels 70 run along the entire lower interior length of the sample container 34, communicating operatively with the upper coolant channels 40a and 40b of connection adapter 32 when the sample container 34 is placed in the U-shaped design 44 (see FIG. 7 and FIG. 8). The cover, 62, is placed on top of the sample tray 60 and pressed into place, forming the cell sample into a thin block that is in intimate contact with the recess 72 of the sample tray 60 over a large surface area. As shown in FIG. 10, only the thin bottom of the sample tray 60 in the area of the recess 72 separates the thin layer block 74 from the flow of coolant 76 through the coolant passage channels 70 when the cryopreservation system is operating.

Several preferred embodiments of the design of the sample container 34 enhance the process of cooling and warming cell samples in the cryopreservation device 30. The recess 72 is set at a depth of between 10 and 200 μm below the edge of the upper surface 71 of the sample tray 60. When the cell sample (not shown) is placed in the recess 72 and the cover 62 is placed on top of the sample tray 60, the cell sample is contacted and pressed into a thin layer block that is on the order of one cell diameter in depth. Generally, based on the described dimensions, the volume of the cell sample placed into the recess 72 is less than or equal to 150 μl. Different amounts of cell sample can be added depending on the overall size of the container 34. The thickness of the material forming the bottom of the recess 72 in the sample tray 60 can be between 100 and 200 μm. Silicon can be used to construct the sample tray 60, due to its ultra-high thermal conductivity at very low temperatures.

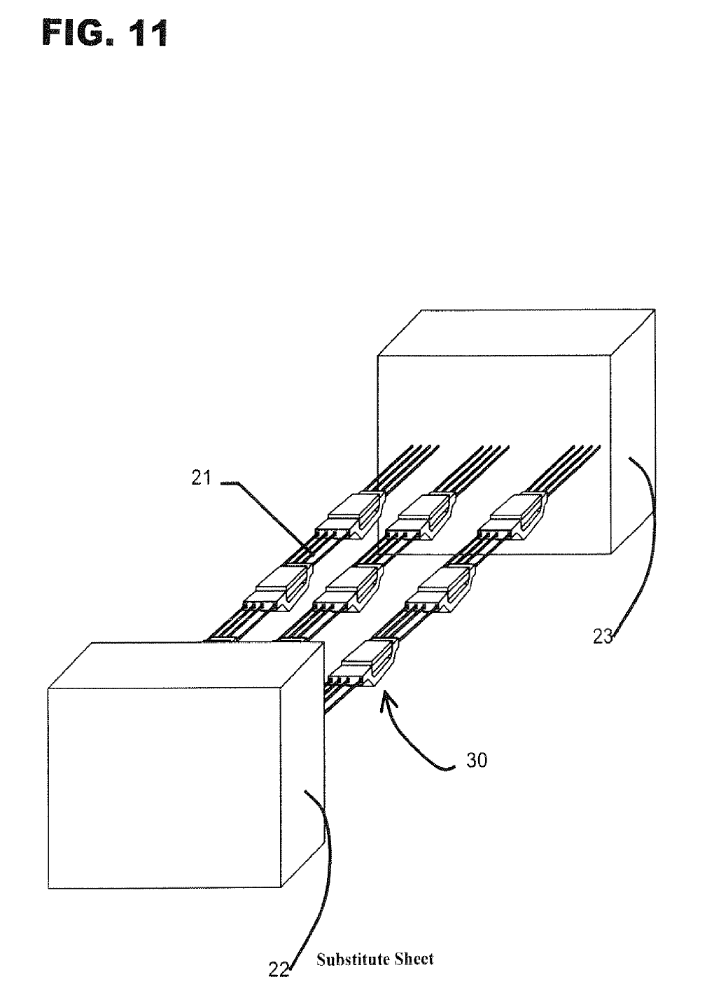

Referring to FIG. 11, at least two or more cryopreservation devices may be operably connected to each other in series or in parallel in order to increase the overall volume of cell samples that the cryopreservation system can simultaneously process. A network of cryopreservation devices 30, connected by OHP 21 may achieve the capacity to process between 1 and 20 ml of cell samples simultaneously. The OHPs may all be connected to a common evaporator 23 and a common condenser 22. Because the control valves. discussed above seals off the flow of coolant to the cell sample container 34, the cell sample container may be removed without shutting down the OHP, and each independent cryopreservation device in the networked system may be added or removed independently.

In the method of the present invention, the cell sample is added into the recess 72 of the sample tray 60 and covered with the cover 62. The cover 62 is then pressed down onto the sample tray 60, spreading the cell sample into a thin block layer inside the cavity formed between the cover 62 and the recess 72. Other methods may be used so long as the thin block layer has a thickness of 10 to 100 μm, depending on the cell type. Preferably embodiment, the cell sample does not require the addition of CPA to prevent intracellular ice formation. Once the cover 62 is in place, the sample container 34 is pressed into the connection adapter 32, aligning the coolant passage channels 70 of the sample container 34 with the corresponding upper coolant channels 46a and 46b of the adapter connecter 32. In particular, the cell sample is positioned to be cooled. During operation, the valves 52a and 52b, which are set to the default non-operating valve position (see FIG. 8B), are moved to the operating valve position (see FIG. 8C). The OHP 21 is then activated, and coolant flows at high speed through the coolant passage channels 70 of the sample tray 60, inducing rapid cooling of the cell sample via heat exchange from the cell sample to the coolant across the thin layer of material forming the bottom of the recess 72 of the sample tray 60. Once the cell sample has cooled to the desired temperature, the valves are moved from the operating position, back to the default non-operating position (see FIG. 8B). Upon the diversion of the coolant away from the sample tray and back through the lower coolant channels in the connection adapter, the sample tray can be removed from the connection adapter, and placed into long-term cold storage. Liquid nitrogen may be used as the coolant in the cryopreservation system 20. Further, nanoparticles may be added to the coolant, forming a nanofluid coolant. Because the nanoparticles possess a much higher thermal conductivity than the surrounding coolant, the rate of heat exchange is greatly enhanced through the use of nanofluid coolant.

Optionally, CPAs may be added to the cell sample to assure that potentially damaging ice crystals will not form in the extracellular fluid during cooling. In this embodiment, the CPAs added into the cell sample may be selected from the following: ethylene glycol, glycerol, 1,2 propylene glycol, dimethylsulfoxide, a small molecular weight polyol, or a combination of polyols. Additionally, any of a variety of other CPAs can be used so long as sufficient heat transfer occurs.

In an alternative method of the present invention the sample container 34 is removed from long-term cold storage, and pressed into the connection adapter 32. During operation, the valves 52a and 52b, which are set to the default non-operating valve position (see FIG. 80), are moved to the operating valve position (see FIG. 8B). The OHP 21 is then activated, and coolant flows at high speed through the coolant passage channels 70 of the sample tray 60, inducing rapid heating of the cell sample via heat exchange from the cell sample to the coolant across the thin layer of material forming the bottom of the recess 72 of the sample tray 60. In one embodiment, water may be used as the coolant. Once the cell sample has warmed to the desired temperature, the valves are moved from the operating position, back to the default non-operating position. Once the valves 52a and 52b have diverted coolant flow away from the sample tray 60 and back through the lower coolant channels 50 in the connection adapter 32, the sample tray 60 may be removed from the connection adapter 32, and the cell sample may be removed from the sample container 34 and used for its desired purpose.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

### DEFINITIONS

As used herein, “cryopreservation” refers to the preservation of a biological specimen at extremely low temperatures. “Vitrification” as used herein refers to solidification without ice crystal formation during the cooling of a cell sample during cryopreservation. “Devitrification” as used herein refers to the formation of ice crystals during the warming of cell samples that are in a state of vitrification. As used herein, “cryoprotectant agent” or “CPA” means a chemical that inhibits the formation of ice crystals during the cooling process of cryopreservation.

As used herein “OHP” or “oscillating heat pipe” refers to a heat exchanging device comprised of a folded loop of thin metal tubing containing a coolant, a condenser, and an evaporator. “Thin film evaporation” as used herein refers to an intensive evaporation process of the thin films of coolants at μm level formed on the capillary surfaces inside OHPs. “Nanoparticles” as used herein refer to inorganic particles of 5˜100 nm in diameter, and “nanofluid” as used herein refers to the suspension of nanoparticles in a fluid medium.

### EXAMPLES

The following examples illustrate the invention.

### Example 1

### Simulation of Cooling Rate of the Device

The present example provides a simulation of cooling rates based on assumed values for the thickness of the sample container and the cell sample, known values for the physical properties of cells and for the cell container material, and a derived value for the heat transfer coefficient of the coolant.

The vitrification technique of preserving cell samples cryogenically is an effective means of preserving living tissues for extended periods while maintaining relatively high viability of the reheated tissue. However, in order to achieve the vitrification of tissues without resorting to the use of potentially toxic levels of CPAs during the cryopreservation process, the tissues must be cooled at an ultra-fast rate. For example, based on the theoretical predictions made using dynamic numerical models (Ren, 1990), cooling rates as high as 10⁶ K/min are required to vitrify a 1M glycerol aquatic solution. For an isotonic solution (300 mOsm NaCl in water), the critical cooling rate should be no less than 10⁷ K/min. In practice, the large molecules commonly resident in the cytoplasm of living cells should function in a manner similar to a CPA to lower the minimum freezing rate that defines the lower limit at which vitrification is possible. However, it remains to be seen whether there exists a device capable of cooling a biological sample at the freezing rate required to induce vitrification.

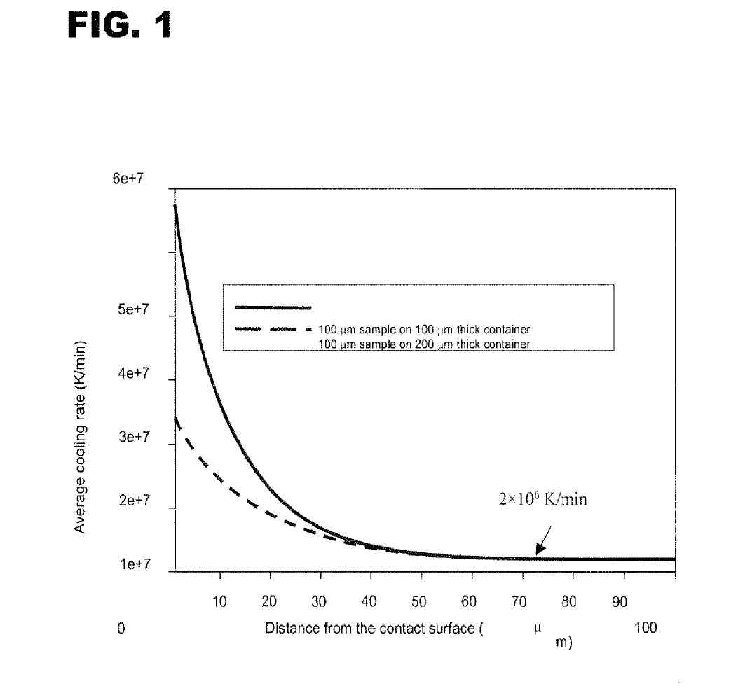

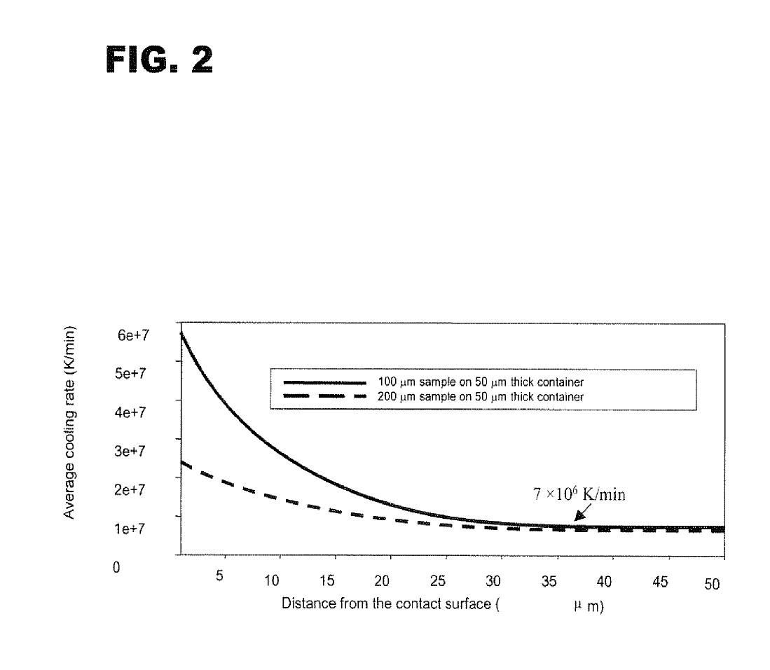

To investigate the thermal performance of the device during its cooling process, a numerical simulation was performed, using assumed and derived physical properties of cells, silicon, and liquid nitrogen, as well as assumed physical dimensions of the cooling device. Values of thermal conductivity, heat capacity, and density were assumed based on known physical properties of cells and silicon, a material from which a flat cell container may be constructed. In addition, a heat transfer coefficient of 1×10⁶ W/m²K was derived by substituting the physical properties of liquid nitrogen into the equations for a thin film evaporation model (Ma, 2004). The average cooling rate of the sample passing the dangerous temperature region (−20 to −90° C.) was calculated using the numerical simulation described above at different locations inside the sample. Cooling rates in excess of 10⁶ K/min were predicted by the numerical simulation for all combinations of values used (see FIG. 1 and FIG. 2).

The results of this numerical simulation of cooling demonstrated that the cryopreservative device that was modeled had the capability of achieving cooling rates in excess of 10⁶ K/min. This cooling rate is sufficient to cool cell samples to cryogenic temperatures with a relatively low risk of forming ice crystals in the cell sample, even in the absence of any cryoprotective additives in the cell sample.

### Example 2

### Simulation of Warming Rate of the Device

The present example provides a simulation of warming rates based on assumed values for the thickness of the sample container and the thickness of the cell sample, known values for the physical properties of cells and the cell container material, and a derived value for the heat transfer coefficient of the coolant.

During the rewarming of the vitrified samples, devitrification may cause cell damage by forming intracellular or extracellular ice crystals, and can occur at relatively modest warming rates. To prevent devitrification, the warming rate should be higher than the critical warming rate for the sample (the minimum warming rate required to prevent devitrification). The incorporation of CPAs during the freezing of cell samples is one possible way to lower the critical warming rate and thereby avoid devitrification during thawing.

However, in a solution of permeating CPA, the critical warming rates are extremely high even for high concentrations of CPAs. For example, 30% (V/V) L-2, 3-Butanediol solution requires a warming rate of greater than 3×10⁷K/min to avoid devitrification. The critical warming rates of the solutions can be significantly lowered by adding a low concentration (5˜10%) of non-permeable CPAs of large molecules such as HES, PVP or PEG with no severe toxic effects on cells. The intracellular large molecules such as proteins and organic salts should also have a similar effects on the survival of cells at warming rates much lower than the critical warming rates of simple CPA solutions. However, it still remained to be determined whether there exists an apparatus capable of developing warming rates high enough to circumvent devitrification while thawing cell samples.

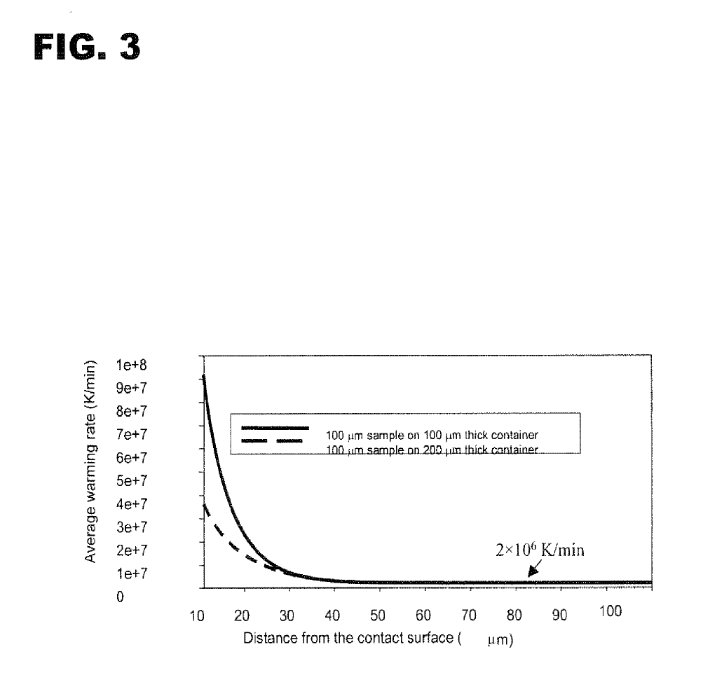

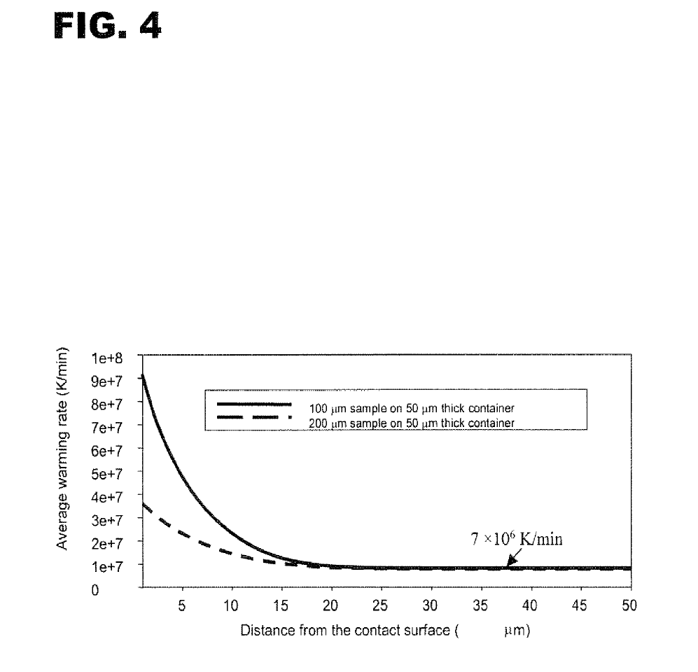

To investigate whether the thermal performance of the device during its warming process was adequate to thaw biological specimens without the danger of damage due to devitrification, a numerical simulation was performed using similar methods to those described above (see Example 1). Rather than liquid nitrogen, water was used as the coolant in the numerical simulation of cell sample warming. The average warming rate of the sample passing the dangerous temperature region (−90 to −20° C.) was calculated at different locations inside the sample and determined to be in excess of 10⁶ K/min (see FIG. 3 and FIG. 4). The heat transfer coefficient was estimated as 2×10⁶ W/m²K (Ma, 2004).

The results of this numerical simulation of warming demonstrated that the cryopreservative device that was modeled had the capability of achieving warming rates in excess of 10⁶ K/min. This warming rate is sufficient to warm cryopreserved cell samples to biological temperatures with a relatively low risk of forming ice crystals, even in the absence of any cryoprotective additives in the cell sample.

### REFERENCES

Ma, C., H. Zhang and J. Zhuang. 2004. Investigation on effective thermal conductivity of oscillating heat pipes. 13th International heat pipe conference. September 19-25.
Ren, H. S., T. C. Hua, G. X. Yu and X. H. Chen. 1990. The crystallization kinetics and the critical cooling rate for vitrification of cryoprotective solutions. Cryogenics. 30:536-540.

What is claimed is:

1. A device for the ultra-fast cooling and cryopreservation of living cells, the device comprising:
a. a sample container having a base and cover that together contact and press a cell sample into a thin layer, whereby the cell sample is within 50 μm to 200 μm of a coolant; and,
b. a connection adapter connected to an OHP with an evaporator attached on one end to the OHP, and a condenser attached to the OHP opposite the evaporator, the adaptor designed and dimensioned for receiving the sample container, whereby the coolant is provided to the sample container.

2. The connection adapter of claim 1, which further comprises a base having opposed wings and a planar member integrally attached to the wings to form a U-shaped design for receiving the sample container.

3. The connection adapter of claim 1, which further comprises at least one pair of internal upper coolant channels that enter from each of the wings and exit through the wing's inner edges, into the recess in the upper surface of the connection adapter, the upper coolant channels located in the wings align with corresponding coolant passage channels in the sample container when the sample container is mounted on the connection adapter.

4. The connection adapter of claim 1, which further comprises at least one internal lower coolant channel that runs the length of the connection adapter and connects internally with the upper internal coolant channels in both wings of the connection adapter.

5. The connection adapter of claim 1, which further comprises at least one set of valves with at least one valve in each wing.

6. The connection adapter of claim 1, which further comprises at least one set of connecting tubes.

7. The sample container of claim 1, which further comprises a base with at least one coolant channel engraved on its upper surface.

8. The sample container of claim 1, which further comprises a sample tray with a shallow recess and a lower surface, a upper surface including at least one coolant passage channel that runs the length of the sample container and forms a connection with the corresponding upper coolant channels at the inner surface of the wings of the connection adapter when the sample tray is placed into the recess on the top of the connection adapter.

9. The sample container of claim 1, which further comprises a cover that rests on the upper surface of the tray.

10. The sample container of claim 1 wherein the recess on the upper surface of the tray is at a depth of between 10 μm and 200 μm.

11. The sample container of claim 1, wherein the cell sample is a cell suspension of ≦150 μl.

12. The sample container of claim 1, wherein the thickness of the material in the tray is between 50 μm and 200 μm.

13. The sample container of claim 1, wherein the tray is made from silicon.

14. A network of two or more cryopreservation devices connected in parallel or in series, to process multiple cell sample volumes equal to between 1 ml and 20 ml.

15. A device for the ultra-fast cooling and cryopreservation of living cells, the device comprising:
a. at least one cell sample container constructed of a thermally conductive material, the container including a cell holding member with a cover whereby the cell holding member and cover are between 10 μm and 200 μm apart, the cover contacts the cell sample and spreads the cells into a thin block layer, the cell container also containing at least one interior coolant passage that directs the flow of coolant fluid past the cell sample at a distance of less than 200 μm;
b. one or more connection adapters with a U-shaped design; and,
c. an OHP connected to fittings on the connection adapters and passing coolant fluid through a condenser on one end and through an evaporator on the opposite end.

16. The cell sample container of claim 15, which further comprises:
a. a planar base, engraved or embossed with at least one straight channel with a U-shaped cross-section with a width of approximately 1 μm that defines the lower interior surface of the coolant passage channels;
b. a planar sample tray with a recess in the upper surface at a depth of between 10 μm and 200 μm and a smooth planar underside that fits to the upper surface of the base and defines the upper surface of the coolant passage channels;
c. a planar cover of thickness of approximately 100 μm that is pressed on top of the sample tray, forming the cell sample between the cover and the sample tray into a thin block layer in the depression of the sample tray.
d. one or more coolant passage channels that run the length of the sample container and carry coolant fluid at a distance of between 50 μm and 200 μm beneath the cell sample.

17. The connection adapter of claim 15, which further comprises:
a. A planar member attached to two opposing wings, forming a U-shaped design to which the sample container removably attaches;
b. interior upper coolant channels located inside each of the opposing wings that carry coolant fluid from the OHP (connected on the outer side of the wing) to the inner sides of the wings, and connected to the sample container when the sample container is mounted on the connector adapter;
c. one or more lower coolant channels located in the planar member and connected to the upper coolant channels in both wings in two Y-intersections;
d. two or more valves (one for each wing) located in the Y-intersections of the upper coolant channels and the lower coolant channel that divert flow away from the upper coolant channels in one setting, and that divert flow away from the lower coolant channel in a second setting
e. at least one set of connecting tubes located on the outer opposing sides of the connection adapter that connect the OHP to the upper coolant channels of the connection adapter.

18. A method for cell cryopreservation through direct vitrification of cell samples, comprising:
a. pressing out a cell sample to a thickness of between 10 μm and 200 μm; and,
b. locating a cooling fluid proximate to the cell sample with the coolant fluid being within 200 μm of the cell sample, whereby heat transfer will occur at a rate of at least 10⁶ K/min to vitrify the cell sample and thereby produce cryopreserved cells.

19. The method of claim 18, wherein the coolant fluid is liquid nitrogen.

20. The method of claim 18, wherein the coolant fluid includes nanoparticles.

21. The method of claim 18, wherein the cells are selected from the group consisting of eukaryotic and prokaryotic cells.

22. The method of claim 18, wherein CPAs may be added to the cell sample.

23. The method of claim 22, wherein said CPA is selected from the group consisting of ethylene glycol, glycerol, 1,2 propylene glycol, dimethylsulfoxide and combinations thereof.

24. The method of claim 22, wherein said CPA is a small molecular weight polyol or a combination of polyols.

25. A method for warming cryopreserved cells, comprising:
a. obtaining a vitrified cell sample in the form of a thin layer block with a thickness of between 10 and 200 μm; and,
b. placing the vitrified cell sample proximal to a flowing coolant, in a manner sufficient to cause heat transfer at a rate of at least 10⁶ K/min, causing the cell sample to reach biological temperatures.

26. The method of claim 25, wherein the coolant fluid is water.

27. The method of claim 25, wherein the coolant fluid includes nanoparticles.

28. The method of claim 25, wherein the cells are selected from the group consisting of eukaryotic and prokaryotic cells.

29. A device for the cooling of living cells, the device comprising a sample container having a base and a cover, whereby the base receives the cells with the cover capable of being actuated to contact the cells and spread the cells into a single layer, with the cells located proximate to a coolant at a distance of between 50 μm and 200 μm from the coolant, the base being made of thermal conductive material to allow for cooling of the cells at a rate of at least 10⁶ K/min.
